(19) United States
(12) Patent Application Publication
(10) Pub. No.: US 2023/0023924 A1
(43) Pub. Date: Jan. 26, 2023

(54) MEASURING SYSTEM AND MEASURING METHOD

(71) Applicant: NIPPON TELEGRAPH AND TELEPHONE CORPORATION, Tokyo (JP)

(72) Inventors: Daiki KOBAYASHI, Tokyo (JP); Atsushi ARATAKE, Tokyo (JP); Kazuaki WATANABE, Tokyo (JP); Masafumi NAKAGAWA, Tokyo (JP)

(73) Assignee: NIPPON TELEGRAPH AND TELEPHONE CORPORATION, Tokyo (JP)

(21) Appl. No.: 17/791,146

(22) PCT Filed: Jan. 8, 2020
(86) PCT No.: PCT/JP2020/000351

§ 371 Date: Jul. 6, 2022

(51) Int. Cl. E02D 1/00; G01N 3/02

(52) U.S. Cl. CPC E02D 1/00; G01N 3/02

(57) ABSTRACT

A measurement system for measuring a subgrade reaction coefficient of a plurality of layers having different depths in a ground is provided. The system includes an object provided on a ground surface of the ground. An earth pressure gauge measures an earth pressure of the plurality of layers with respect to a load of the object. A settlement gauge measures a settlement amount of the plurality of layers with respect to the load of the object. The disclosed technology calculates the subgrade reaction coefficient of the plurality of layers on the basis of the earth pressure and the settlement amount.

### TECHNICAL FIELD

The present invention relates to a measurement system and a measurement method.

### BACKGROUND ART

A subgrade reaction coefficient is one of the numerical values that represent bearing capacity characteristics such as deformation, strength, and the like in a structure foundation ground, and is used for design of a structure. For example, NPL 1 and NPL 2 disclose a plate loading test method in which ground is excavated, a jack is installed, a load is applied to a ground surface via a rigid loading plate, and a loading pressure and a settlement amount of the loading plate accompanying an action of a reaction force are measured. The subgrade reaction coefficient is calculated on the basis of the slope of a graph indicating the relationship between the load pressure and the settlement amount of the loading plate.

### CITATION LIST

### Non Patent Literature

NPL 1: “Method for Plate Load Test”, the Japanese Geotechnical Society, [online], [searched on Dec. 23, 2019], the Internet <URL: https://jiban.or.jp/file/file/jgs1521_201109.pdf>

NPL 2: “Plate Loading Test”, CSS Engineering Co., Ltd., [online], [searched on Dec. 23, 2019], the Internet <URL: https://www.css24.jp/download/img/pdf/6-6heiban.pdf>

### SUMMARY OF THE INVENTION

### Technical Problem

However, in the related-art plate loading test method, excavating of the ground and a jack that supports a reaction force are necessary, and thus, the measurement device becomes larger and the cost increases as the ground is deeply excavated. In addition, because the soil property of the ground varies depending on the depth, in order to measure the subgrade reaction coefficients of a plurality of layers having different soil properties, it is necessary for the operator to dig a plurality of positions of the ground in accordance with the respective layers, and thus, which is costly and takes time and effort.

An object of the present invention made in view of such circumstances is to provide a measurement system and a measurement method that can easily measure the subgrade reaction coefficients of a plurality of layers having different depths in the ground while reducing cost.

### Means for Solving the Problem

A measurement system according to an embodiment of the present invention is a measurement system for measuring a subgrade reaction coefficient of a plurality of layers having different depths in a ground. The measurement system includes an object provided on a ground surface of the ground, an earth pressure gauge configured to measure an earth pressure of the plurality of layers with respect to a load of the object, a settlement gauge configured to measure a settlement amount of the plurality of layers with respect to the load of the object, and a calculation device configured to calculate the subgrade reaction coefficient of the plurality of layers on the basis of the earth pressure and the settlement amount.

A measurement method according to an embodiment is a measurement method for measuring a subgrade reaction coefficient of a plurality of layers having different depths in a ground. The method includes providing an object on a ground surface of the ground, measuring an earth pressure of the plurality of layers with respect to a load of the object, measuring a settlement amount of the plurality of layers with respect to the load of the object, and calculating the subgrade reaction coefficient of the plurality of layers on the basis of the earth pressure and the settlement amount.

### Effects of the Invention

According to the present invention, it is possible to provide a measurement system and a measurement method that can easily measure subgrade reaction coefficients of a plurality of layers having different depths in a ground while reducing cost.

### BRIEF DESCRIPTION OF DRAWINGS

FIG. 1 is a diagram illustrating an example of a configuration of a measurement system according to an embodiment of the present invention.

FIG. 2 is a diagram illustrating an example of a configuration of the measurement system according to the embodiment of the present invention.

FIG. 3 is a diagram illustrating an example of a relationship between an earth pressure and a settlement amount according to the embodiment of the present invention.

FIG. 4 is a flowchart illustrating an example of a measurement method according to the embodiment of the present invention.

### DESCRIPTION OF EMBODIMENTS

Hereinafter, an embodiment of the present invention will be described in detail with reference to the drawings.

Measurement System

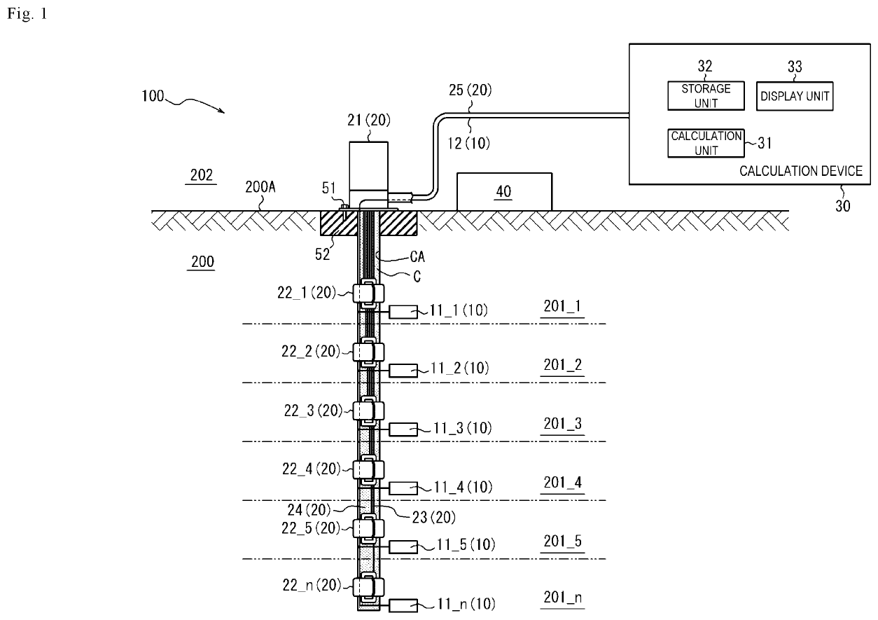

A measurement system 100 according to the embodiment of the present invention will be described with reference to FIGS. 1 to 3.

The measurement system 100 is a measurement system that measures subgrade reaction coefficients of a plurality of layers 201_k (k=1 to n) having different depths (soil properties) in a ground 200. The measurement system 100 includes an earth pressure gauge 10, a settlement gauge 20, a calculation device 30, and an object 40 with a predetermined load.

The earth pressure gauge 10 includes a plurality of layered earth pressure gauges 11_k (k=1 to n) and a signal wire 12. The earth pressure gauge 10 measures the earth pressures of the plurality of layers 201 with respect to the load of the object 40. The earth pressure gauge 10 outputs measurement data of the earth pressures of the plurality of layers 201 with respect to the load of the object 40 to the calculation device 30.

The earth pressures of the plurality of layers 201 vary depending on the load of the object 40. For example, the earth pressures of the plurality of layers 201 when a first load is applied to the ground surface 200A differ from the earth pressures of the plurality of layers 201 when a second load different from the first load is applied to the ground surface 200A.

The plurality of layered earth pressure gauges 11 is respectively inserted in the plurality of layers 201 from a side surface CA of the borehole C formed by drilling the ground 200. The operator drills the ground 200 to form a borehole C to a location deeper than the deepest layer (for example, the layer 201_n ) at which a subgrade reaction coefficient is measured by the measurement system 100. Then, the operator inserts the plurality of layered earth pressure gauges 11 connected at any interval with the signal wire 12 from an inlet of the borehole C. Then, the operator moves the plurality of layered earth pressure gauges 11 inside the borehole C so that positions of the plurality of layered earth pressure gauges 11 are at positions respectively corresponding to the plurality of layers 201. Then, the operator stops each of the plurality of layered earth pressure gauges 11 at an appropriate position inside the borehole C, and drives the end portion on the opposite side of the measurement unit of the layered earth pressure gauge 11 horizontally with a hammer or the like, thereby inserting the layered earth pressure gauge 11 into the corresponding layer of the plurality of layers 201 from the side surface CA of the borehole C. The diameter of the borehole C is only required to be such that the plurality of layered earth pressure gauges 11 can be inserted, but the size is preferably small.

For example, the layered earth pressure gauges 11_k are inserted into the layers 201_k from the side surface CA of the borehole C. Because the layered earth pressure gauges 11 are respectively inserted into the plurality of layers 201 from the side surface CA of the borehole C, the operator does not need to dig a plurality of positions of the ground in accordance with respective layers as in the related art. Thus, the digging volume can be significantly smaller than that of the related-art, and thus labor of the operator can be saved.

The plurality of layered earth pressure gauges 11 measures the earth pressures of the plurality of layers 201 with respect to the load of the object 40. The plurality of layered earth pressure gauges 11 is connected to the calculation device 30 via the signal wire 12, and the earth pressures of the plurality of layers 201 with respect to the load of the measured object 40 are output to the calculation device 30. For example, the layered earth pressure gauges 11_k measure the earth pressures of the layers 201_k with respect to the load of the object 40, and outputs measurement data of the earth pressures of the layers 201_k to the calculation device 30 via the signal wire 12. The earth pressures are measured by the layered earth pressure gauges 11 respectively inserted into the plurality of layers 201 from one dug location, the earth pressure gauge 10 can easily measure the earth pressures of the plurality of layers 201.

The plurality of layered earth pressure gauges 11 is formed by, for example, plate-type earth pressure gauges. Because the plurality of layered earth pressure gauges 11 is formed by the plate-type earth pressure gauges, the operator can easily insert the layered earth pressure gauges 11 respectively into the plurality of layers 201 from the side surface CA of the borehole C without disturbing the ground 200.

For details of the plate-type earth pressure gauges, for example, the following documents can be referred to. “GTI-E201-S plate-type soil pressure transducers”, Kyowa Electronic Instruments Co., Ltd., the Internet <URL: https://www.kyowa-ei.com/jpn/file/download/support/download/catalog/gti-e201-s_catalog_j2019_01_jpn.pdf>.

The settlement gauge 20 includes a measurement unit 21, a plurality of anchors 22_k (k=1 to n), a rod 23, a space filler 24, and a signal wire 25. The settlement gauge 20 measures settlement amounts of the plurality of layers 201 with respect to the load of the object 40. The settlement gauge 20 outputs measurement data of the settlement amounts of the plurality of layers 201 with respect to the load of the object 40 to the calculation device 30.

The settlement amounts of the plurality of layers 201 vary depending on the load of the object 40. For example, the settlement amounts of the plurality of layers 201 when the first load is applied to the ground surface 200A and the settlement amounts of the plurality of layers 201 when the second load different from the first load is applied to the ground surface 200A are different.

The measurement unit 21 is provided on the ground surface 200A and is fixed to a concrete base 52 of the ground 200 by, for example, an anchor bolt 51. The measurement unit 21 is connected to the plurality of anchors 22 via the signal wire 25, and acquires the amount of movement of the plurality of anchors 22 in a vertical direction with respect to the load of the object 40. The measurement unit 21 measures the settlement amounts of the plurality of layers 201 with respect to the load of the object 40 on the basis of the amount of movement.

Further, the measurement unit 21 is connected to the calculation device 30 via the signal wire 25, and outputs the settlement amounts of the plurality of layers 201 with respect to the load of the measured object 40 to the calculation device 30. For example, the measurement unit 21 outputs measurement data of the settlement amounts of the layers 201_k with respect to the load of the object 40 to the calculation device 30 via the signal wire 25.

The anchors 22 are provided inside the borehole C respectively corresponding to the plurality of layers 201. For example, the anchors 22_k are provided inside the borehole C corresponding to the layers 201_k. By providing the anchors 22 at positions respectively corresponding to the plurality of layers 201 inside the borehole C, the settlement gauge 20 can easily measure the settlement amounts of the plurality of layers 201.

The operator inserts the plurality of anchors 22 coupled at any intervals from the inlet of the borehole C by the rod 23. The operator then moves the plurality of anchors 22 inside the borehole C so that positions of the plurality of anchors 22 are positions respectively corresponding to the plurality of layers 201. The operator then fixes the plurality of anchors 22 at proper positions inside the borehole C. Then, the operator fills the inside of the borehole C with a space filler 24 having a rigidity less than that of the ground 200. Thus, it is possible to suppress collapse of the borehole C.

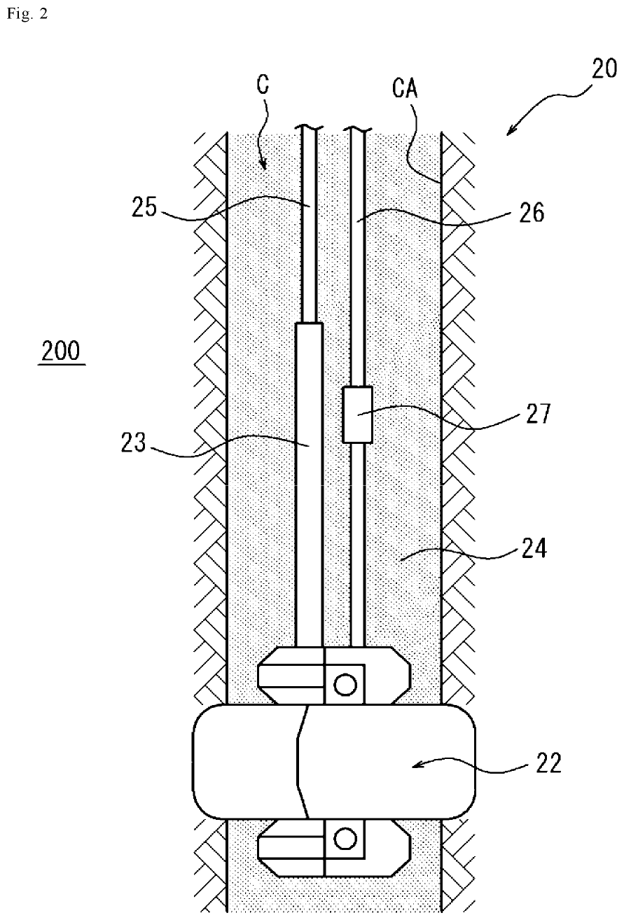

Referring now to FIG. 2, an example of a method for an operator to secure the plurality of anchors 22 inside the borehole C will be described.

The settlement gauge 20 may further include, for example, a pressurizing tube 26, a check valve 27, and the like. Further, the settlement gauge 20 may include hydraulic anchors as the anchors 22. In this case, the operator causes water to flow through the pressurizing tube 26 to apply a water pressure to the hydraulic anchors to expand ring diameters of the hydraulic anchors. Thus, the hydraulic anchors dig into the side surface CA of the borehole C, and thus the operator can secure the hydraulic anchors at appropriate positions inside the borehole C. A high-pressure state in the hydraulic anchors is maintained by the check valve 27. Note that when the plurality of anchors 22 has a mechanism that mechanically expands, the operator can fix the plurality of anchors 22 at the proper positions inside the borehole C even when the settlement gauge 20 does not have the configuration described above.

In view of movement of soil particles of the ground 200 accompanying stress propagation with respect to the load of the object 40, the plurality of anchors 22 is preferably provided at the same positions as the plurality of layered earth pressure gauges 11 or at positions closer to the ground surface 200A than the plurality of layered earth pressure gauges 11 in a horizontal direction in the same layer of the ground 200. For example, the anchors 22_k are preferably provided at the same positions as the layered earth pressure gauges 11_k in the horizontal direction in the layers 201_k of the ground 200, or at positions closer to the ground surface 20A than the layered earth pressure gauges 11_k.

The rod 23 accommodates the signal wire 25 coupling the plurality of anchors 22 at any intervals therein, and protects the signal wire 25. A displacement generated in the plurality of anchors 22 by application of the load of the object 40 to the ground surface 200A is transmitted to the measurement unit 21 via the signal wire 25 housed within the rod 23.

The space filler 24 fills the inside of the borehole C. The space filler 24 is preferably appropriately selected by the operator in consideration of the rigidity of the ground 200, and is preferably formed from a material having a rigidity less than that of the ground 200. When the space filler 24 is a solid material with a strong rigidity, errors occur between the ground 200 around the borehole C and the displacement generated in the plurality of anchors 22, and measurement accuracy deteriorates. Thus, the space filler 24 is preferably formed from a fluid such as bentonite, cement, or a mixture of water, for example.

The calculation device 30 includes a calculation unit 31, a storage unit 32, and a display unit 33. The calculation device 30 is provided on the ground 202 or the ground surface 200A. The calculation device 30 calculates the subgrade reaction coefficient of the plurality of layers 201 on the basis of the measurement data of the earth pressures of the plurality of layers 201 with respect to the load of the object 40 input from the earth pressure gauge 10 and the measurement data of the settlement amounts of the plurality of layers 201 with respect to the load of the object 40 input from the settlement gauge 20.

The calculation unit 31 may be configured by dedicated hardware, or may be configured by a general purpose processor or a processor dedicated to a specific processing.

The calculation unit 31 calculates the subgrade reaction coefficients of the plurality of layers 201 on the basis of the measurement data of the earth pressures of the plurality of layers 201 with respect to the load of the object 40 and the measurement data of the settlement amounts of the plurality of layers 201 with respect to the load of the object 40. The calculation unit 31 stores the subgrade reaction coefficients of the plurality of layers 201 in the storage unit 32. The calculation unit 31 causes the display unit 33 to display, for example, the measurement data of the earth pressures of the plurality of layers 201 for each phase of the load of the object 40, the measurement data of the settlement amounts of the plurality of layers 201 for each phase of the load of the object 40, a graph indicating the relationship between the earth pressures and the settlement amounts with respect to the load of the object 40, the subgrade reaction coefficients of the plurality of layers 201, and the like.

For example, the calculation unit 31 calculates the subgrade reaction coefficient of the predetermined layer 201_i on the basis of the earth pressure of the predetermined layer 201_i measured by the earth pressure gauge 10 and the settlement amount of the predetermined layer 201_i measured by the settlement gauge 20 when the first load is applied to the ground surface 200A of the ground 200, and the earth pressure of the predetermined layer 201_i measured by the earth pressure gauge 10 and the settlement amount of the predetermined layer 201_i measured by the settlement gauge 20 when the second load different from the first load is applied to the ground surface 200A of the ground 200.

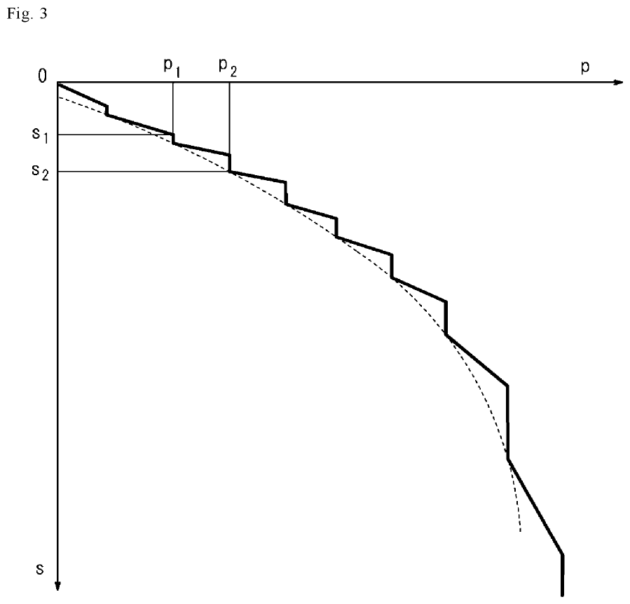

The calculation unit 31 calculates the subgrade reaction coefficient of the predetermined layer 201_i on the basis of the slope of the graph indicating the relationship between the earth pressure and the settlement amount as illustrated in FIG. 3. For example, the subgrade reaction coefficient Ki of the predetermined layer 201_i can be represented as the following equation.

$$[ Math . 1 ]$$

$${k}_{i} = \frac{Δ p}{Δ s} = \frac{{p}_{2} - {p}_{1}}{{s}_{2} - {s}_{1}} \qquad ( 1 )$$

Kᵢ is the subgrade reaction coefficient [kN/m³] of the layer 201_i. p₁ is the earth pressure [kN/m²] of the layer 201_i when the first load is applied to the ground surface 200A of the ground 200. p₂ is the earth pressure [kN/m²] of the layer 201_i when the second load is applied to the ground surface 200A of the ground 200. s₁ is the settlement amount [m] of the layer 201_i when the first load is applied to the ground surface 200A of the ground 200. s₂ is the settlement amount [m] of the layer 201_i when the second load is applied to the ground surface 200A of the ground 200.

In other words, the calculation unit 31 calculates the subgrade reaction coefficient Kᵢ of the layer 201_i on the basis of the earth pressure p₁ and the settlement amount si of the layer 201_i when the first load is applied to the ground surface 200A of the ground 200, and the earth pressure p₂ and the settlement amount s₂ of the layer 201_i when the second load is applied to the ground surface 200A of the ground 200.

The operator is capable of changing the load of the object 40 in a stepwise manner. As the operator cuts the load of the object 40 more finely, the graph illustrating the relationship between the earth pressure and the settlement amount becomes smoother. Consequently, the calculation unit 31 can calculate the subgrade reaction coefficient with high accuracy. Thus, the operator is only required to finely control the load of the object 40 when it is desired to increase the measurement accuracy of the subgrade reaction coefficient in the measurement system 100.

The storage unit 32 includes one or more memories, and may include, for example, semiconductor memory, magnetic memory, optical memory, and the like. Each of the memories included in the storage unit 32 may function as, for example, a main storage device, an auxiliary storage device, or a cache memory. The memories need not necessarily be provided inside the calculation device 30, and may be provided on the outside of the calculation device 30. The storage unit 32 stores any information used for operation of the calculation device 30. The storage unit 32 stores, for example, the measurement data of the earth pressures of the plurality of layers 201 for each phase of the load of the object 40, the measurement data of the settlement amounts of the plurality of layers 201 for each phase of the load of the object 40, the graph indicating the relationship between the earth pressure and the settlement amount with respect to the load of the object 40, the subgrade reaction coefficients of the plurality of layers 201, and the like. The storage unit 32 stores also various programs, data, and the like, for example, in addition to the above.

The display unit 33 is, for example, a speaker, a liquid crystal display, an organic electro-luminescence (EL) display, or the like. The display unit 33 displays, for example, the measurement data of the earth pressures of the plurality of layers 201 for each phase of the load of the object 40, the measurement data of the settlement amounts of the plurality of layers 201 for each phase of the load of the object 40, the graph indicating the relationship between the earth pressure and the settlement amount with respect to the load of the object 40, the subgrade reaction coefficients of the plurality of layers 201, and the like.

The object 40 is, for example, a vehicle, and is provided on the ground surface 200A of the ground 200. The object 40 is changed stepwise by the operator. Thus, the measurement system 100 can measure the earth pressures of the plurality of layers 201 and the settlement amounts of the plurality of layers 201 in a wide range.

Measurement Method

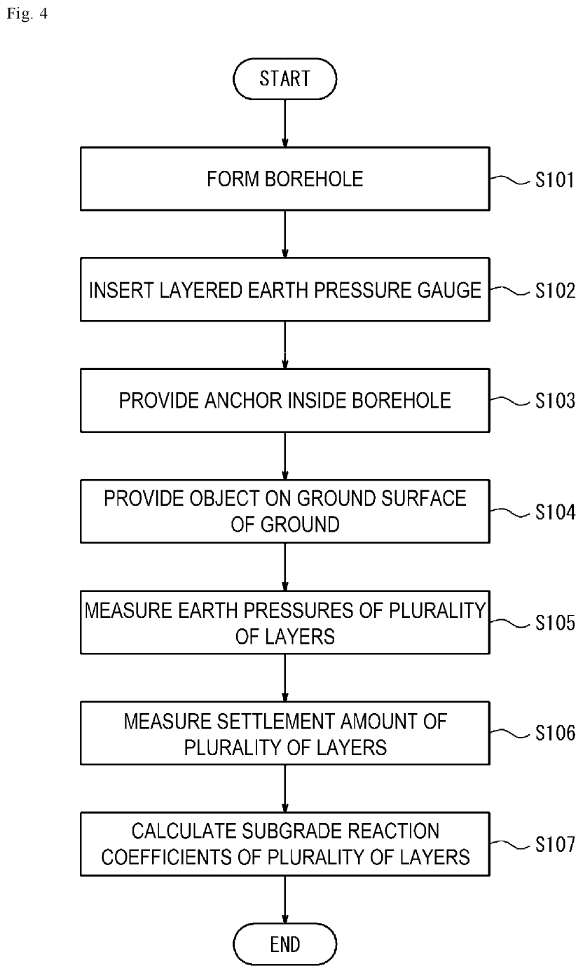

Next, a measurement method according to the embodiment of the present invention will be described with reference to FIG. 4.

In step (forming step) S101, the operator drills the ground 200 to form the borehole C.

In step (insertion step) S102, the operator inserts the layered earth pressure gauge 11 into each of the plurality of layers 201 from the side surface CA of the borehole C.

In step (installation step) S103, the operator provides the anchors 22 respectively corresponding to the plurality of layers 201 inside the borehole C.

In step (installation step) S104, the operator provides the object 40 on the ground surface 200A of the ground 200.

In step (first measuring step) S105, the earth pressure gauge 10 measures the earth pressures of the plurality of layers 201 with respect to the load of the object 40. The earth pressure gauge 10 outputs measurement data of the earth pressures of the plurality of layers 201 with respect to the load of the object 40 to the calculation device 30.

In step (second measuring step) S106, the settlement gauge 20 measures the settlement amounts of the plurality of layers 201 with respect to the load of the object 40. The settlement gauge 20 outputs measurement data of the settlement amounts of the plurality of layers 201 with respect to the load of the object 40 to the calculation device 30.

In step (calculation step) S107, the calculation device 30 calculates the subgrade reaction coefficients of the plurality of layers 201 on the basis of the measurement data of the earth pressures of the plurality of layers 201 with respect to the load of the object 40 input from the earth pressure gauge 10 and the measurement data of the settlement amounts of the plurality of layers 201 with respect to the load of the object 40 input from the settlement gauge 20. For example, the calculation device 30 calculates the subgrade reaction coefficient Kᵢ of the predetermined layer 201_i on the basis of the earth pressure p₁ and the settlement amount si of the predetermined layer 201_i when the first load is applied to the ground surface 200A of the ground 200, and the earth pressure p₂ and the settlement amount 52 of the predetermined layer 201_i when the second load is applied to the ground surface 200A of the ground 200.

As described above, the measurement system 100 according to the present embodiment includes an earth pressure gauge configured to measure an earth pressure of a plurality of layers with respect to a load, a settlement gauge configured to measure a settlement amount of the plurality of layers with respect to the load, and a calculation device configured to calculate a subgrade reaction coefficient of the plurality of layers on the basis of the earth pressure and the settlement amount.

In the measurement method according to the present embodiment, the earth pressure of the plurality of layers with respect to the load is measured, and the settlement amount of the plurality of layers with respect to the load is measured, and the subgrade reaction coefficient of the plurality of layers is calculated on the basis of the earth pressure and the settlement amount.

Thus, the subgrade reaction coefficient of a layer present in a deep location of the ground can be measured without the need for a large scale measurement device. Further, because the subgrade reaction coefficients of the plurality of layers having different depths can be easily measured by digging one location of the ground, labor of the operator can be eliminated and cost can be reduced. That is, the measurement system 100 and the measurement method can be achieved that are capable of easily measuring the subgrade reaction coefficients of a plurality of layers having different depths in the ground while reducing cost.

Further, because the layered earth pressure gauges 11 are respectively inserted into the plurality of layers 201 from the side surface CA of the borehole C, the operator does not need to dig a plurality of positions of the ground in accordance with respective layers as in the related art. Thus, the digging volume can be significantly smaller than that of the related-art, and thus labor of the operator can be saved.

Further, by measuring the earth pressures by the layered earth pressure gauges 11 respectively inserted into the plurality of layers 201 from one drilled location, the earth pressure gauge 10 can easily measure the earth pressure of the plurality of layers 201.

Further, by providing the anchors 22 at positions respectively corresponding to the plurality of layers 201 inside the borehole C, the settlement gauge 20 can easily measure the settlement amounts of the plurality of layers 201.

Further, because the inside of the borehole C is filled with the space filler 24 and the space filler 24 has a rigidity that is less than the rigidity of the ground 200, an error is less likely to occur between the ground 200 around the borehole C and displacement generated in the plurality of anchors 22, and thus measurement accuracy can be improved.

The above embodiment has been described as a representative example, but it is apparent to those skilled in the art that many changes and substitutions are possible within the spirit and scope of the present invention. Therefore, the present invention should not be construed as being limited by the embodiment described above, and various modifications and changes can be made without departing from the scope of the claims. For example, the order of the processes described in the flowchart of the embodiment is not limited to the above and can be changed as appropriate. Additionally, a plurality of processes may be combined into one process, or one process may be divided.

Modification Example

As the calculation device according to the present embodiment, for example, a data logger device having a graphical display function, a general purpose computer, a dedicated computer, a workstation, a PC, an electronic notepad, or the like can be applied.

Other Modification Examples

The present invention is not limited to the above embodiment and modification examples. For example, the various processes described above may be executed not only in chronological order as described but also in parallel or on an individual basis as necessary or depending on the processing capabilities of the apparatuses that execute the processes. In addition, appropriate changes can be made without departing from the spirit of the present invention.

### REFERENCE SIGNS LIST

10 Earth pressure gauge
11 Layered earth pressure gauge
12 Signal wire
20 Settlement gauge
21 Measurement unit
22 Anchor
23 Rod
24 Space filler
25 Signal wire
26 Pressurizing tube
27 Check valve
30 Calculation device
31 Calculation unit
32 Storage unit
33 Display unit
40 Object
100 Measurement system
200 Ground
200A Ground surface
201 Layer
202 Ground

1. A measurement system for measuring a subgrade reaction coefficient of a plurality of layers having different depths in a ground, the measurement system comprising a processor configured to execute a method comprising:
measuring an earth pressure of the plurality of layers with respect to a load of an object placed on a ground surface of the ground;
measuring a settlement amount of the plurality of layers with respect to the load of the object; and
calculating the subgrade reaction coefficient of the plurality of layers based on the earth pressure and the settlement amount.

2. The measurement system according to claim 1, wherein
the measuring the earth pressure further comprises inserting a layered earth pressure gauge into a layer of the plurality of layers from a side surface of a borehole formed by drilling the ground, and
the measuring the settlement amount further comprises measuring based on an amount of movement in a vertical direction of an anchor provided inside the borehole and corresponding to the layer of the plurality of layers.

3. The measurement system according to claim 2, the processor further configured to execute a method comprising:
causing filling inside the borehole with a space filler.

4. The measurement system according to claim 3, wherein the space filler has a rigidity that is lower than a rigidity of the ground.

5. The measurement system according to claim 1, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

6. A method for measuring a subgrade reaction coefficient of a plurality of layers having different depths in a ground, the method comprising:
providing an object placed on a ground surface of the ground;
measuring an earth pressure of the plurality of layers with respect to a load of the object;
measuring a settlement amount of the plurality of layers with respect to the load of the object; and
calculating the subgrade reaction coefficient of the plurality of layers on a basis of the earth pressure and the settlement amount.

7. The method according to claim 6, further comprising:
drilling the ground to form a borehole;
inserting a layered earth pressure gauge from a side surface of the borehole into a layer of the plurality of layers; and
providing an anchor inside the borehole, the anchor corresponding to the layer of the plurality of layers,
wherein the earth pressure is measured with the layered earth pressure gauge, and
the settlement amount is measured on a basis of an amount of movement of the anchor in a vertical direction.

8. The measurement system according to claim 2, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

9. The measurement system according to claim 3, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

10. The method according to claim 6, wherein
the measuring the earth pressure further comprises inserting a layered earth pressure gauge into a layer of the plurality of layers from a side surface of a borehole formed by drilling the ground, and
the measuring the settlement amount further comprises measuring based on an amount of movement in a vertical direction of an anchor provided inside the borehole and corresponding to the layer of the plurality of layers.

11. The method according to claim 6, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

12. The method according to claim 10, the method further comprising:
filling with a space filler inside the borehole.

13. The method according to claim 10, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

14. The method according to claim 12, wherein
the space filler has a rigidity that is lower than a rigidity of the ground.

15. The method according to claim 12, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

16. A device for measuring a subgrade reaction coefficient of a plurality of layers having different depths in a ground, the device comprising a processor configured to execute a method comprising:
measuring an earth pressure of the plurality of layers with respect to a load of an object provided on a ground surface of the ground;
measuring a settlement amount of the plurality of layers with respect to the load of the object; and
calculating the subgrade reaction coefficient of the plurality of layers on a basis of the earth pressure and the settlement amount.

17. The device according to claim 16, wherein
the measuring the earth pressure further comprises inserting a layered earth pressure gauge into a layer of the plurality of layers from a side surface of a borehole formed by drilling the ground, and
the measuring the settlement amount further comprises measuring based on an amount of movement in a vertical direction of an anchor provided inside the borehole and corresponding to the layer of the plurality of layers.

18. The device according to claim 16, wherein
the calculating further comprises calculating a subgrade reaction coefficient of a predetermined layer on a basis of an earth pressure and a settlement amount of the predetermined layer when a first load is applied to the ground surface, and an earth pressure and a settlement amount of the predetermined layer when a second load different from the first load is applied to the ground surface.

19. The device according to claim 17, the processor further configured to execute a method comprising:
causing filling inside the borehole with a space filler.

20. The device according to claim 19, wherein
the space filler has a rigidity that is lower than a rigidity of the ground.
